(19) United States
(12) Patent Application Publication
(10) Pub. No.: US 2003/0212200 A1
(43) Pub. Date: Nov. 13, 2003

(54) Colorant dispersions having improved adhesion

(76) Inventor: Thomas M Bellas, Bridgewater, NJ (US)

Correspondence Address: Abelman Frayne & Schwab, 150 East 42nd Street, New York, NY, 10017-5612, US

(21) Appl. No.: 10/258,918

(22) PCT Filed: Apr. 30, 2001
(86) PCT No.: PCT/US01/13899

(51) Int. Cl. C03C 17/00; C08K 3/00

(52) U.S. Cl. 524/612; 523/160

(57) ABSTRACT

This invention relates to colorant dispersion formulations containing the typical levels of pigment, dispersing agents, rheology modifiers, and other components conventionally employed in colorant dispersions, but in combination with various polyethylenimine derivatives, with or without the addition of a fatty acid modified polymer and/or an acrylic resin. These formulations combine good properties for the preparation of the colorant dispersion, as well as providing the final colored surface coating or other product with enhanced properties, notably improved adhesion of the pigment to the surface.

### CROSS-REFERENCE TO RELATED APPLICATIONS

This application claims priority from co-pending U.S. Provisional Application 60/200,938, filed May 1, 2000.

### FIELD OF THE INVENTION

The invention relates generally to pigmented colorant dispersions for coloring surface coatings, such as paints and, more particularly, to the inclusion in pigmented colorant dispersions of compounds to improve and promote the adherence of the surface coating, as well as improving other properties, to the surface to which it is applied.

### BACKGROUND OF THE INVENTION

Color is an important factor in the sale, marketing, and even the utility of almost all articles of commerce. Colorants, or controlled pigment dispersions, tinters and toners, as they are also called, have been known and used to impart color in various applications since the late 1940's. By careful selection from among the various classifications of product chemistries utilized to produce the colorants, these formulations can be targeted for various product applications ranging from textile printing to ink-jet printing, and from decorative coatings to specialized industrial coating applications.

Regardless of the application, however, a key performance indicator is that the colorant must not detract from the properties of the ultimate application in which it is used to impart the desired color. This presents a challenge to the formulator to balance the formulation properties of the colorant dispersion, and the application performance characteristics for its use in the finished surface coating product. For purposes of describing the invention, the terms “pigment dispersion” and “colorant dispersion”, or simply “colorant” are used interchangeably herein.

Many ingredients which are required to facilitate dispersion of the pigment in the colorant, and also those ingredients required to provide good compatibility of the colorant in the product in which it will be used, for example, in a paint or ink formulation, can lead to detrimental application performance properties in the finish of the product to which the surface coating or ink has been applied. In general, the introduction of components into the formulation of a colorant is particularly difficult since the formulator must balance the requirements of compatibility with the product, with those of the product's application performance.

In addition, end users requiring coloration of finished products have sought colorants that can be utilized in a wide variety of application product chemistries to avoid requirements for multiple colorant lines, and thus additional stock keeping units (SKU's). This trend towards more flexible colorants resulted in the development and use of (and hence the term) “universal colorants”.

In the paint and coatings application areas, this universal colorant demand requires that the product work in both water-based and solvent-based coatings. This presents an even greater challenge to the formulator, since now considerably more development is needed to balance the additional ingredients required to broaden the compatibility profile, without adversely impacting on the application performance properties. The introduction of components into the formulation of universal colorants necessitates an extremely difficult requirement for compatibility while still maintaining product application performance.

Finally, as ongoing regulations and toxicity information on various ingredients used historically in the preparation of colorants continue to evolve, formulations must be made which are more friendly to the environment. This includes the use of low- or no-VOC (volatile organic compound) content ingredients, HAP-free (hazardous air pollutant-free) materials, APE-free (alkyl phenol ethoxylate-free) components, and other materials generally regarded as safe for the environment. This has further increased the challenge and the level of complexity for the formulator.

Thus, a continuing need for formulations which improve this balance of colorant preparation and physical properties, with finished colored surface coating product application properties have resulted.

Polyethylenimine derivatives have been reported to provide utility as adhesion promoters, and also some corrosion control, when used as additives to paints, coatings, adhesives, and ink formulations. No work had been disclosed regarding formulating these derivatives into colorant dispersions.

### SUMMARY OF THE INVENTION

It is an object of the present invention is to provide a colorant dispersion which has good properties for its preparation and dispersion characteristics of the pigment it contains.

It is another object of the present invention to provide a colorant that has good physical properties in the finished application for which it is used to impart color.

It is a principal object of the present invention to provide the above with environmentally friendly components in the colorant formulation.

Colorant formulations for achieving one or more of the above mentioned objects, and methods for the preparation of such formulations, have now been found. Thus, formulations containing various polyethylenimine derivatives, with or without a fatty acid modified polymer, and/or a modified acrylic resin, in combination with the pigment, a vehicle for the pigment, dispersing agents, and other components at typical levels normally associated with colorant formulations, have been found to provide a colorant possessing significantly improved physical properties in the finished application for which it is used to impart color when cmpared with pigmented dispersions in which polyethylenimine is not present.

### DETAILED DESCRIPTION OF THE INVENTION

Colorant formulations in accordance with the present invention contemplate in one embodiment the incorporation of from about 0.1% to 10.0%, by weight, of a polyethylenimine derivative, preferably from about 1 to about 3%, by weight, in the pigmented dispersion. In another embodiment, it is contemplated to also include from about 0.1 to about 10 percent by weight of a fatty acid modified polymer and/or from about 0.1% to about 10 percent by weight of a modified acrylic resin, in combination with a pigment, dispersing agents, and other components at loading levels normally associated with colorant formulations.

While the potential for use of polyethylenimine derivatives as additives to various applications has been disclosed, for example, the ability of these products as adhesion promoters for coatings and their reported contribution to corrosion control in coatings over metal, there have been no patents or publications reporting the formulating of these derivatives into colorant dispersions.

Thus, most unexpectedly, results have demonstrated that polyethylenimine derivatives dramatically improved the compatibility of colorant compositions, particularly in water-based surface coatings. The anticipated adhesion improvements were also observed, but were complicated by the fact that the colorant dried to a film which could not be easily reincorporated into the colorant, or rewetted by the colorant. While this is an important advantage for colorants used in ink-jet applications, this is less than desirable for a colorant dispersion in surface coating applications where this inability to reincorporate dried colorant could cause seeding in both the colorant and final coating application, resulting in degraded dry film properties, such as gloss and grind.

It has been found that for paint and coating applications that the inclusion of a fatty acid modified polymer and/or an acrylic resin with the polyethylenimine derivative enabled the dried film to be successfully reincorporated into the surface coating without seeding or other adverse effects. This embodiment of the present invention improved the processing of the colorant by improving the wetting ability and dispersability of the pigment compared to the use of polyethylenimine alone, and minimized the generation of foam during processing. Furthermore, the combination did not have an adverse effect upon the adhesion properties of polyethylenimine in coating applications, while the ability of the dried colorant to be reincorporated into the colorant made clean-up of the manufacturing equipment used to prepare the colorant easier.

The inclusion of an acrylic resin in the colorant composition adds to gloss and hardness and provides a protective shield since it is a film former. Acrylic resins are also good wetting agents which facilitate high pigment loadings. It also acts as a binder to hold the pigment on the substrate to which it is being applied.

Another problem associated with the use of colorants in, for example, paint bases, is that at high levels of addition, e.g., in deep or accent bases, the colorants typically contribute to a viscosity drop of the product, possibly as a result of adverse interaction with the rheology modifiers in the surface coating formulation. Most unexpectedly, the colorants of the present invention incorporating polyethylenimine derivatives, with or without the additional resin and/or polymer, also eliminated the problem of viscosity loss upon the addition of high levels, or loadings, of the improved pigment dispersion of the invention to the base paint to be colored.

The colorants containing polyethylenimine derivatives have also been seen to impart improved water sensitivity in coating applications.

Exemplary of the polyethylenimine derivatives which can be employed to advantage are low molecular weight ethylenimine copolymers, medium and high molecular weight homopolymers, modified high molecular weight ethylenimine homopolymers, high molecular weight polyaminodiamine, hydroxyethylated water-soluble polyethylenimines and water-soluble polyethylenimine-epichlorohydrin.

The colorants containing polyethylenimine derivatives can be prepared using no-VOC components, APE-free components, and combinations thereof to provide enhanced properties and performance, while using environmentally friendly components.

Both organic and inorganic pigments can be used provided they are water-soluble and/or solvent soluble and they are capable of being dispersed in the vehicle in which they are dissolved. Exemplary of the pigments which can be employed are phthalo green pigment, yellow oxide pigment, red oxide pigment, and carbon black pigment, both organic and inorganic.

In solvent-based colorant formulations, the polyethylenimine derivatives of the present invention provide similarly enhanced properties, but the solvent has a negative effect on the dry-time of such solvent-based product since it retards the drying time. This tendency to retard drying can be minimized through the selection of suitable driers, chelating agents, and other components of the colorant formulation to once again balance the colorant and product performance properties.

The applications for which one or more of the disclosed colorant formulations of the present invention have demonstrated utility include inks, including demanding ink-jet applications, silicone emulsions, stains, preservative stains, wood deck treatments, architectural and industrial paints and coatings, metal coatings, latex emulsions, water-based paints, solvent-based paints, and other related applications. Typically, the pigment dispersion amounts from about 2% to about 15%, by weight, of the coating, paint, ink, etc., in which it is incorporated. The quantity employed is dependent upon the depth of the color desired.

The following examples serve to illustrate the nature of the present invention, but are not intended to limit or delineate the scope of the invention, which is to be determined only by reference to the claims. The quantities set forth in the examples are in percent (%) by weight.

### EXAMPLE I

The ingredients listed below in Table 1, with the exception of magnesium silicate and phthalo green pigment were initially charged into a 2-liter stainless steel container. The contents were then mixed on a dispersator having a 1.5 inch diameter Cowles blade.

Stirring at low speed was maintained until a uniform solution was obtained. Then magnesium silicate and phthalo green pigment were slowly added, with continued agitation.

The mixture was mixed for 30 minutes at 4000 r.p.m. It was then transferred into a 2 quart Chicago Boiler sandmill with 1.5 pints of 1.3 mm glass beads. It was milled for 20 minutes at 2400 R.P.M. using cooling water to prevent the temperature from exceeding 140° F.

TABLE 1

| Component | Quantity |
|---|---|
| Water | 45.5 |
| Fatty Acid Modified Polymer¹ | 3.0 |
| Polyethylenimine Derivative² | 1.0 |
| Surfactant³ | 3.0 |
| Acrylic Polymer⁴ | 5.0 |
| Defoamer⁵ | 0.2 |
| Caustic Solution⁹ | 0.1 |
| Biocide⁶ | 0.2 |
| Magnesium Silicate⁷ | 2.0 |
| Phthalo Green Pigment⁸ | 40.0 |

¹EFKA 1503 ® (Lubizol)
²Luparol SC-86X ™ water soluble polyethylenimine-epichlorohydrin (BASF)
³Tergitol ® 15-5-9 (Union Carbide)
⁴Joncryl ® 63 acrylic polymer (S. C. Johnson)
⁵Drew Plus L-475 ®
⁶Nuosept ® 495 (Huls America)
⁷Talc 7 is a talc extender (Barretts Minerals)
⁸Duritant ® Green 264-0414 is a green pigment green #7 (Sun Chemical)
⁹50% KOH (Dow)

### EXAMPLES 2 TO 6

The preparative procedure and the sequence of Example 1 above was followed in Examples 2-6. While certain ingredients were either added or deleted, and certain quantities were changed, the general procedure employed was the same.

TABLE 2

| Component | Quantity |
|---|---|
| Water | 24.8 |
| Rheology Modifier¹⁰ | 0.6 |
| Surfactant^{3a} | 2.0 |
| Fatty Acid Modified Polymer¹ | 6.0 |
| Polyethylenimine Derivative² | 2.0 |
| Acrylic Polymer⁴ | 4.0 |
| Caustic Solution⁹ | 0.1 |
| Biocide⁶ | 0.1 |
| Defoamer⁵ | 0.2 |
| Rheology Modifier^{10a} | 0.2 |
| Yellow Oxide Pigment Y-42¹¹ | 60.0 |

^{3a}Strodex PK-90 (Dexter)
¹⁰Lapointe RD (Southern Clay)
^{10a}Cellosize (Union Carbide)
¹¹810 M (Bayer)

TABLE 3

| Component | Quantity |
|---|---|
| Water | 21.75 |
| Rheology Modifier¹⁰ | .60 |
| Surfactant^{3a} | 2.00 |
| Fatty Acid Modified Polymer¹ | 6.00 |
| Acrylic Polymer⁴ | 4.00 |
| Polyethylenimine Derivative² | 2.00 |
| Caustic Solution⁹ | 0.05 |
| Biocide⁶ | 0.20 |
| Defoamer⁵ | 0.20 |
| Red Oxide Pigment¹² | 63.00 |

¹²R-1599 (Elementis)

TABLE 4

| Component | Quantity |
|---|---|
| Water | 50.9 |
| Fatty Acid Modified Polymer¹ | 10.0 |
| Surfactant³ | 3.0 |
| Polymeric Dispersant¹⁴ | 3.0 |
| Polyethylenimine Derivative² | 1.0 |
| Acrylic Polymer⁴ | 3.0 |
| Biocide⁶ | 0.2 |
| Caustic Solution⁹ | 0.7 |
| Defoamer⁵ | 0.2 |
| Carbon Black 7¹³ | 28.0 |

¹³Raven 1040 (Columbian)
¹⁴EFKA 4560 (Lubrizol)

TABLE 5

| Component | Quantity |
|---|---|
| Water | 54.4 |
| Rheology Modifier¹⁰ | 0.2 |
| Acrylic Polymer⁴ | 5.0 |
| Surfactant³ | 2.0 |
| Polyvinylpyrrolidone¹⁵ | 2.0 |
| Polyethylenimine Derivative² | 1.0 |
| Defoamer⁵ | 0.1 |
| Caustic Solution⁹ | 0.6 |
| Biocide⁶ | 0.2 |
| Carbon Black 7¹³ | 34.5 |

¹⁵PVP K-15 (ISP Technologies)

TABLE 6

| Component | Quantity |
|---|---|
| Water | 22.92 |
| Rheology Modifier¹⁰ | .30 |
| Acrylic Polymer⁴ | 3.33 |
| Polyvinylprrolidone¹⁵ | 2.00 |
| Polyethylenimine Derivative² | 3.00 |
| Surfactant^{3a} | 2.00 |
| Biocide⁶ | .20 |
| Defoamer⁵ | .20 |
| Caustic Solution⁹ | .05 |
| Red Oxide Pigment¹² | 66.00 |

The testing results for Examples 1-6 are tabulated below. Rather than reporting individual test results with a numerical value, the designations poor, average (avg), good and excellent (exc) have been used.

Adhesion properties were measured according to the standard cross-hatch test (ATSM 3359-95); color devlopment was measured through strength measurements on a colorimeter.

Flocculation/compatibility was performed using the standard finger-rub on a drawdown.

Water sensitivity was determined using an inverted watchglass over the drawdown with a droplet of water on it; the water drop is wiped off and a comparison is made of properties under the water droplet versus those not under the droplet.

Wet-edge dry/rewetting testing was done by drawing down colorant on glass, then scraping it off and attempting to reincorporate it into the colorant.

| Tests | | Color | Compat | Water | Re- |
|---|---|---|---|---|---|
| Conducted | Adhesion | Development | Aqueous | Sensitivity | wetting |
| Examples | good | exc. | good | good | good |
| 1-6 | | | | | |

### EXAMPLES 7-10

Four (4) separate samples of a blue pigment dispersion having no VOC was prepared from BASF Luconyl Blue 6900 pigment by adding 1%, 2%, 3% and 4%, respectively, of Lupasol P, which is a high m.w. ethylenimine homopolymer colorant from BASF.

One gram of each of the above samples was added to 50 grams of a white alkyd base and the gloss readings were taken. The gloss reading of a control, which consisted of 1 gram of Luconyl Blue 6900 in 50 grams of a white alkyd base was also measured. Gloss readings were made using a standard gloss meter.

The control gave a reading of 68, while Examples 7, 8, 9 and 10 gave readings of 66, 79, 78, and 85, respectively, which indicates that the inclusion of polyethylenimine derivatives in accordance with the present invention contribute significantly to the improved gloss of the colorant.

### EXAMPLE 11

In Example 11, four (4) standard commercial architectural non-VOC colorants (the 802 series) manufactured by Creanova, Inc., Parsippany, N.J., the assignee herein, were compared for adhesion against the colorants made in accordance with Examples 1-4 (the 871 series) of the present invention.

Tests were conducted using two (2) types of paint bases made by Coronado Paint Company and tested pursuant to ASTM Test D 3359-95. The results are tabulated below.

ADHESION TEST

| | Paint Base Clear | | | Paint Base Deep | | |
|---|---|---|---|---|---|---|
| | (Coronado 80-37) @ 12Y | | | (Coronado 1280-38) @ 8Y | | |
| Colorant | 24 hrs. | 7 days | 30 days | 24 hrs. | 7 days | 30 days |
| 802-5511 | 1B | 5B | 5B | 0B | 0B | 1B |
| 871 (R3796) | 5B | 5B | | 5B | 5B | |
| 802-1811 | 0B | 3B | 1B | 5B | 5B | 5B |
| 871-1871 | 5B | 5B | | 5B | | |
| 802-1045 | 1B | 3B | 1B | 5B | 5B | 5B |
| 871-1017 | 5B | 5B | | 5B | 5B | |
| 802-9907 | 5B | 5B | | 1B | 1B | 0B |
| 871 (R-3795) | 5B | 5B | | 4B | 5B | |

NA = Insufficient film remaining on metal panel for testing
5B = None
4B = Less than 5%
3B = 5.15%
2B = 15-35%
1B = 35-65%
0B = Greater than 65%

It is evident from the results that superior pigment adhesion was obtained by employing colorants made in accordance with the present invention when tested according to ASTM at both 24 hours and 7 days since most of the results had a 5B rating which indicates that no film came off during the test. Accordingly, the inclusion of polyethylenimines in the pigmented dispersion resulted in superior adhesion when compared to non-polyethylenimines containing dispersions.

### EXAMPLE 12

In this example four (4) commercial architectural colorants (877-series) and four (4) commercial industrial colorants (896-series) manufactured by Creanova, Inc., of Parsippany, N.J., the assignee herein, were compared for scrub testing against the colorants made in accordance with Examples 1-4 of the present invention (the 871 series). In each experiment noted below 6 grams of colorant were incorporated in 50 grams of paint base.

Tests were conducted in accordance with ASTM Test D 3450-90 using Pratt-Lambert's Z 4193, a clear base having no color. The results are set forth below in tabular form.

SCRUB TESTING

| | Cycles | | Cycles |
|---|---|---|---|
| 877-5513 | 555 | 896-5501 | 527 |
| 871 (R-3796) | 718 | 871 (R3796) | 676 |
| 877-1812 | 656 | 896-1801 | 632 |
| 871-1870 | 770 | 871-1870 | 614 |
| 877-1035 | 651 | 896-1001 | 707 |
| 871-1017 | 789 | 871-1017 | 745 |
| 877-9998 | 577 | 896-9940 | 642 |
| 871 (R-3795) | 560 | 871 (R-3795) | 642 |

It is evident from the results that in five (5) of the eight (8) compositions, a significantly greater number of cycles were needed to remove the colorant of the present invention, when compared with commercially available colorants. In one instance, the number of cycles needed were the same.

What is claimed is:

1. A pigment dispersion, which comprises:
(a) a pigment;
(b) a vehicle for the pigment;
(c) one or more dispersing agents; and
(d) a polyethylenimine derivative.

2. The dispersion of claim 1 and further including a member selected from the group consisting of a fatty acid modified polymer, a modified acrylic resin, and mixtures thereof.

3. The dispersion of claim 1, wherein the polyethylenimine derivative is from about 0.1% to about 10%, by weight, of the dispersion.

4. The dispersion of claim 2, wherein the fatty acid modified polymer and the modified acrylic resin are from about 0.1% to about 10%, by weight, of the dispersion.

5. The dispersion of claim 1, wherein the polyethylenimine derivatives are selected from the group consisting of low molecular weight ethylenimine copolymers, medium and high molecular weight ethylenimine homopolymers, modified high molecular weight ethylenimine homopolymers, high molecular weight polyamino diamine, hydroxylated water-soluble polyethylenimines and water-soluble polyethylenimine-epichlorohydrin.

6. The dispersion of claim 1, wherein the pigment is selected from organic and inorganic pigments.

7. A latex water-based coating composition comprising from about 2% to about 15%, by weight, of the pigment dispersion of claim 1.

8. A latex water-based surface coating composition comprising from about 2% to about 15%, by weight, of the pigment dispersion of claim 4.

9. An ink for ink jet printing comprising from about 2% to about 15%, by weight, of the pigment dispersion of claim 1.

10. An ink for ink jet printing comprising from about 2% to about 15%, by weight, of the pigment dispersion of claim 3.

11. A water-based paint comprising from about 2% to about 15%, by weight, of the pigment dispersion of claim 1.

12. A solvent-based paint comprising from about 2% to about 15%, by weight, of the pigment dispersion of claim 1.

13. A silicone emulsion comprising from about 2% to about 15%, by weight, of the pigment dispersion of claim 1.

14. A preservative stain comprising from about 2% to about 15%, by weight, of the pigment dispersion of claim 1.

15. A water-based paint having a pigmented dispersion dispersed therein, which comprises:
(a) a pigment selected from organic and inorganic pigments;
(b) water;
(c) one or more dispersing agents;
(d) a polyethylenimine derivative selected from the group consisting of low molecular weight ethylenimine copolymers, medium and high molecular weight ethylenimine homopolymers, modified high molecular weight ethylenimine homopolymers, high molecular weight polyamino diamine, hydroxylated water-soluble polyethylenimine-epichlorohydrin; and
(e) a member selected from the group consisting of a fatty acid modified polymer, a modified acrylic resin, and mixtures thereof.

16. The water-based paint of claim 15, wherein the polyethylenimine derivative is from about 0.1% to about 10% by weight, of the dispersion.

17. The water-based paint of claim 15, wherein the fatty acid modified polymer, the modified acrylic polymer, and mixtures thereof, are from 0.1 to about 10%, by weight, of the dispersion.

18. A latex water-based coating composition having a pigmented dispersion dispersed therein, which comprises:
(a) a pigment selected from organic and inorganic pigments;
(b) water;
(c) one or more dispersing agents;
(d) a polyethylenimine derivative selected from the group consisting of low molecular weight ethylenimine copolymers, medium and high molecular weight ethylenimine homopolymers, modified high molecular weight ethylenimine homopolymers, high molecular weight polyamino diamine, hydroxylated water-soluble polyethylenimine-epichlorohydrin; and
(e) a member selected from the group consisting of a fatty acid modified polymer, a modified acrylic resin, and mixtures thereof.

19. The latex water-based paint of claim 18, wherein the polyethylenimine derivative is from about 0.1% to about 10% by weight, of the dispersion.

20. The latex water-based paint of claim 18, wherein the fatty acid modified polymer, the modified acrylic polymer, and mixtures thereof, are from 0.1 to about 10% by weight, of the dispersion.

21. A solvent-based paint having a pigmented dispersion dispersed therein, which comprises:
(a) a pigment selected from organic and inorganic pigments;
(b) water;
(c) one or more dispersing agents;
(d) a polyethylenimine derivative selected from the group consisting of low molecular weight ethylenimine copolymers, medium and high molecular weight ethylenimine homopolymers, modified high molecular weight ethylenimine homopolymers, high molecular weight polyamino diamine, hydroxylated water-soluble polyethylenimine-epichlorohydrin; and
(e) a member selected from the group consisting of a fatty acid modified polymer, a modified acrylic resin, and mixtures thereof.

22. The solvent-based paint of claim 21, wherein the polyethylenimine derivative is from about 0.1% to about 10% by weight, of the dispersion.

23. The solvent-based paint of claim 21, wherein the fatty acid modified polymer, the modified acrylic polymer, and mixtures thereof, are from 0.1 to about 10%, by weight, of the dispersion.

24. A silicone emulsion having a pigmented dispersion dispersed therein, which comprises:
(a) a pigment selected from organic and inorganic pigments;
(b) water;
(c) one or more dispersing agents;
(d) a polyethylenimine derivative selected from the group consisting of low molecular weight ethylenimine copolymers, medium and high molecular weight ethylenimine homopolymers, modified high molecular weight ethylenimine homopolymers, high molecular weight polyamino diamine, hydroxylated water-soluble polyethylenimine-epichlorohydrin; and
(e) a member selected from the group consisting of a fatty acid modified polymer, a modified acrylic resin, and mixtures thereof.

25. The silicone emulsion of claim 24, wherein the polyethylenimine derivative is from about 0.1% to about 10% by weight, of the dispersion.

26. The silicone emulsion of claim 24, wherein the fatty acid modified polymer, the modified acrylic polymer, and mixtures thereof, are from 0.1 to about 10%, by weight, of the dispersion.

27. A preservative stain having a pigmented dispersion dispersed therein, which comprises:
(a) a pigment selected from organic and inorganic pigments;
(b) water;
(c) one or more dispersing agents;
(d) a polyethylenimine derivative selected from the group consisting of low molecular weight ethylenimine copolymers, medium and high molecular weight ethylenimine homopolymers, modified high molecular weight ethylenimine homopolymers, high molecular weight polyamino diamine, hydroxylated water-soluble polyethylenimine-epichlorohydrin; and
(e) a member selected from the group consisting of a fatty acid modified polymer, a modified acrylic resin, and mixtures thereof.

28. The preservative stain of claim 27, wherein the polyethylenimine derivative is from about 0.1% to about 10% by weight, of the dispersion.

29. The preservative stain of claim 27, wherein the fatty acid modified polymer, the modified acrylic polymer, and mixtures thereof, are from 0.1 to about 10%, by weight, of the dispersion.
